(19) United States
(12) Patent Application Publication
(10) Pub. No.: US 2015/0293705 A1
(43) Pub. Date: Oct. 15, 2015

(54) FORMATTING AND CAPACITY EXPANSION IN A DATA STORAGE DEVICE

(71) Applicant: SEAGATE TECHNOLOGY LLC, Cupertino, CA (US)

(72) Inventors: David Richard Kaiser, Apple Valley, MN (US); Monty Aaron Forehand, Loveland, CO (US)

(73) Assignee: SEAGATE TECHNOLOGY LLC, Cupertino, CA (US)

(21) Appl. No.: 14/250,637

(22) Filed: Apr. 11, 2014

(51) Int. Cl. G06F 3/06; G06Q 20/40

(52) U.S. Cl. CPC G06F 3/0607; G06F 3/0679; G06F 3/0661; G06F 3/0608; G06Q 20/40; G06F 2206/1014; G06F 2003/0692

(57) ABSTRACT

Methods, systems, and devices are described for a data storage device, such as a hard disk drive or solid state drive, that may be initially formatted to an initial capacity. The data storage device may continue to be formatted to add additional capacity to the device. In some examples, a data storage device may be shipped from a factory having an initial capacity, with formatting completed in the field. According to certain examples, the additional capacity may be provided to a user of the data storage device upon satisfaction of one or more conditions. For example, a user may purchase additional capacity, upon which the data storage device may be instructed to provide the additional capacity for use by the user.

### SUMMARY

The present disclosure provides one or more improved systems, methods, and/or apparatuses for data storage device formatting and capacity modification. According to various examples, a data storage device, such as a hard disk drive or solid state drive, may be initially formatted to an initial capacity. The data storage device may continue to be formatted to add additional capacity to the device. In some examples, a data storage device may be shipped from a factory having an initial capacity, with formatting completed in the field. According to certain examples, the additional capacity may be provided to a user of the data storage device upon satisfaction of one or more conditions. For example, a user may purchase additional capacity, upon which the data storage device may be instructed to provide the additional capacity for use by the user.

In some examples, the data storage device may initiate a purchase transaction with an external authority for the user to purchase the additional capacity and, after the user has completed the purchase transaction, the data storage device may receive an authorization from the external authority to provide the additional capacity for use by the user. In some examples, one or more operational parameters of the data storage device may be modified after receipt of the authorization from the external authority, such as, for example, available storage areas for storage of user data, a part number associated with the data storage device, or a sector size for the additional capacity.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram representation of an example data storage device and host computer configured and operated in accordance with various embodiments.

FIG. 2 is a block diagram representation of an example of a storage controller and storage media in accordance with various embodiments.

FIG. 3A is a block diagram representation of partially formatted storage media in a data storage device in accordance with various embodiments.

FIG. 3B is a block diagram representation of fully formatted storage media in a data storage device in accordance with various embodiments.

FIG. 4 is a flowchart illustration of the operational steps of a method for formatting and capacity expansion in a data storage device in accordance with various embodiments.

FIG. 5 is a flowchart illustration of the operational steps of another method for formatting and capacity expansion in a data storage device in accordance with various embodiments.

FIG. 6 is a flowchart illustration of the operational steps of another method for formatting and capacity expansion in a data storage device in accordance with various embodiments.

### DETAILED DESCRIPTION

The present disclosure generally relates to formatting and capacity expansion in data storage devices. In accordance with various embodiments, a storage device, such as a hard disk drive (HDD) or a solid state drive (SSD) is provided which may be formatted to a first capacity during manufacture of the device, and that may include additional capacity in addition to the first capacity. In some examples, the additional capacity may not be formatted, and formatting of the additional capacity may begin after the storage device is powered on by a user. In certain examples, the additional capacity may be provided in a SSD and used for overprovisioning. In other examples, the additional capacity may be made available for storage of user data if one or more conditions are met, such as payment or other authorization to access the additional capacity. In still further examples, the first capacity may be formatted using a 512 byte sector size, and the additional capacity may be formatted according to advanced format 4 kilobyte sector size.

Such additional capacity may provide a flexible storage device, whose available storage capacity is variable so that as the need for more storage arises the user can access a greater portion of the free space within the device memory to thereby increase the capacity of the storage device. Furthermore, in examples where the additional capacity is purchased by the user following the initial purchase of the storage device, some costs associated with the additional storage capacity may be deferred until a point that the additional capacity is required. In examples where the user operates a relatively large number of storage devices, such as at a data center or cloud storage facility, such cost deferral can provide significant operational advantages due to the ability to expand capacity without hardware changes, while keeping the initial capital expense associated with the storage capacity lowered.

Furthermore, such techniques for drive capacity expansion and/or formatting in the field may result in various manufacturing efficiencies in the manufacturing process of storage devices. Such efficiencies may include, for example, a reduced number of different varieties of storage devices needed to be manufactured, thus simplifying overhead associated with demand forecasting, management, and manufacturing increased varieties of storage devices.

Consequently, a reduced number of part numbers may be required as part of the manufacturing process. In some examples, a storage device may be initially formatted to have a traditional sector size of 512 bytes, but the additional capacity may be capable of being formatted according to an advanced format sector size of 4096 bytes. The advanced format may be selectable by a user, with the additional capacity formatted according to the advanced format, any data stored in the initially formatted storage media may be transferred to the additional capacity, and the initially formatted storage media may be reformatted according to the advanced format. Thus, enhanced flexibility may be provided according to some techniques.

Additionally, such manufacturing efficiencies may include a reduction in cycle time, in examples where additional capacity is formatted in the field at a user location. Because less than all of the available capacity is formatted, the storage devices may be coupled with test fixtures for a reduced amount of time, thus allowing more storage devices to be processed through a given set of equipment (e.g., test equipment) during a given time. In some examples, the amount of time required to format the additional capacity of the storage devices may range from tens to hundreds of hours. Thus, a reduced amount of equipment is necessary to manufacture a given number of storage devices, which may result in many millions of dollars in reduced expense associated with, for example, purchase and maintenance of such equipment, operation of such equipment, additional manufacturing floor space, and utility overhead for cooling and electricity.

Various examples described herein are made in reference to solid state drives, which generally include non-volatile solid-state memory, which may exhibit faster data transfer performance than a traditional hard disk drive (HDD) having rotating magnetic media. As a result, such devices can be used as standalone replacement for an HDD and/or as a cache for an HDD. One difference between, e.g., an SSD and an HDD, is that the memory cells of an SSD have a finite life, measured as a function of number of erase/write cycles applied the memory cells. While an HDD may also exhibit wear (e.g., mechanical wear) that limits life of the device, the magnetic disks that are used as data storage media are not considered to be life-limited based on the number of erase/write cycles applied. It will be readily understood by those of skill in the art that various of the techniques described herein may be applied to SSDs or HDDs, and when referring to a data storage device, such a device may include a SSD or HDD.

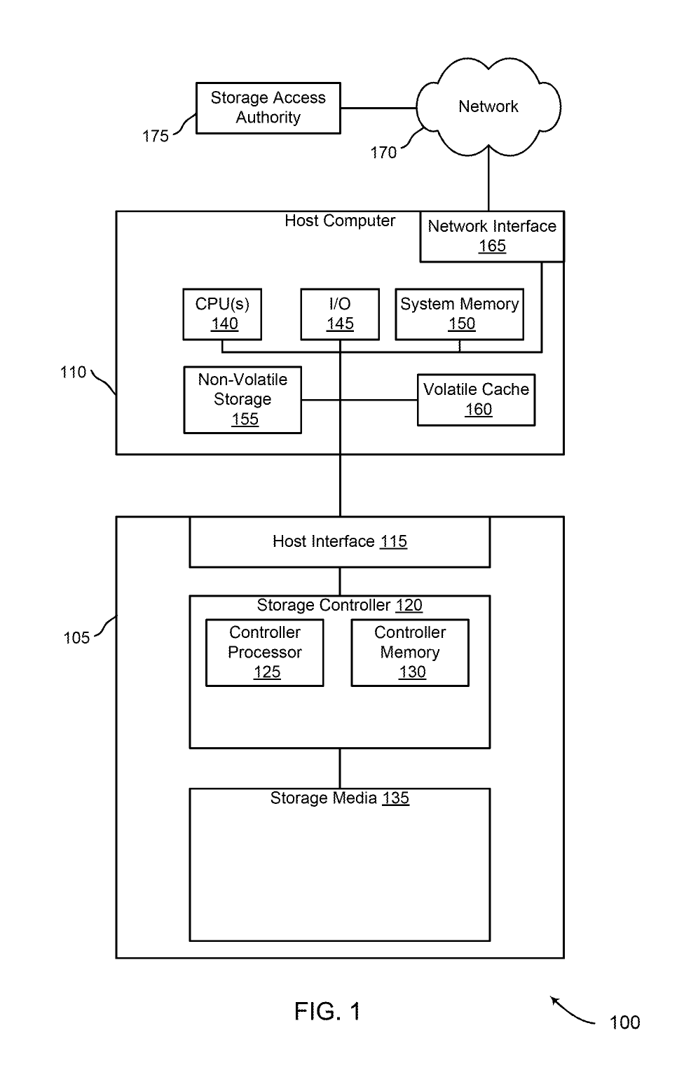

With reference now to FIG. 1, a block diagram illustrates a system 100 having a data storage device 105 (such as an SSD or HDD) according to various examples of the present disclosure. The device 105 is configured as a non-volatile storage device, in which data from host computer 110 is received at the device 105, processed, and stored. The device 105 may be any type of persistent storage device, including an SSD or HDD as mentioned above, but may also be a thumb drive, memory card, embedded device storage, etc. The device 105 may include a host interface 115 that facilitates communications between the device 105 and the host computer 110.

The device 105 of this example includes one or more storage controllers 120, which may include a controller processor 125, which may be a general-purpose or special-purpose processors that perform operations of the device 105. The storage controller 120 may include any combination of microprocessors, digital signal processor (DSPs), application specific integrated circuits (ASICs), field programmable gate arrays (FPGAs), or other equivalent integrated or discrete logic circuitry suitable for performing the various functions described herein. The controller processor 125 may be in communication with a controller memory 130, which may store computer readable code that may be executed by the controller processor 125 to perform various operations of the device 105, including storing/reading data to/from storage media 135 and providing/receiving data to/from host interface 115. In some examples, as will be described in more detail below, the storage media 135 may be partially formatted when the device 105 is provided to a user, and the controller processor 125 may perform operations to complete formatting of the storage media 135 when the device 105 is installed and powered-on at a user site. The additional capacity provided through the completion of the formatting may be indicated to the user, who may then elect to access this additional capacity through a purchase that may unlock the additional capacity, for example.

Functions that may be provided by the controller storage controller 120 include, for example, functions related to storage and retrieval of data to/from the storage media 130. Such functions may include, for example, address translation/mapping, caching, wear-leveling operations if the storage media 135 includes solid state storage, and encryption/decryption operations. Such functions may be implemented using any combination of hardware, software, and/or firmware. As mentioned above, storage controller 120 includes controller memory 125, which may include non-volatile memory, and which may also include volatile random access memory (RAM). The RAM may be used, among other things, to cache data read from or written to storage media 135, map logical to physical addresses, and store other operational data used by the controller processor 125 and other components of the device 105.

The host computer 110 may also include a number of components, including one or more central processing units (CPUs) 140, input/output circuitry 145, and system memory 150. The host computer 110 may use the device 105 as a lowest level of persistent storage, or the device 105 may be acting as an intermediate level of cache for another layer of non-volatile storage (e.g., hard disk drive). The host computer 110 and device 105 may be commonly coupled to a power supply (not shown), or may include separate power supplies/sources. Host computer 110 also includes non-volatile storage 155, and volatile cache 160 which may be used, for example, to store data as needed by the host computer 110.

As mentioned above, in some examples the storage device 105 may have additional capacity that is available beyond an initial capacity of the device 105. Such additional capacity may be made available through completion of formatting of the additional capacity, for example, although in certain examples the additional capacity may already be formatted. According to some examples, the storage device 105 may provide an indication to the host computer 110 that additional capacity is available, and the host computer 110 may provide a prompt to a user, such as through a storage application or utility, that additional capacity is available. If the user elects to gain access to the additional capacity, a storage access authority 175 may be accessed to provide credentials that may be required to gain access to the additional capacity. Such a storage access authority may be, for example, a manufacturer or supplier of the storage device 105, that may offer credentials for access to some or all of the additional capacity if the user pays a fee.

The storage access authority may be accessed through, for example, network interface 165 of the host computer 110, and a network 170, such as the Internet. The credentials, such as a passcode, may be transmitted from the storage access authority 175 to the storage device 105, through network 170 and host computer 110, or may be provided to the user who may then enter them into an application or utility that may unlock access to the additional capacity of the storage media 135. Once the storage device 105 has received the authorization to allow access to the additional capacity, the controller processor 125 may modify one or more operational parameters of the data storage 105. Such operational parameters may include providing access to additional available storage areas for storage of user data, and, in some examples, providing an updated part number associated with the data storage device 105 (e.g., stored in controller memory 130 and provided when properties of the data storage device 105 are accessed). In some examples, formatting parameters may be modified if a user desires to alter a storage format of the storage device 105 from a traditional format to an advanced format, as will be discussed in more detail below.

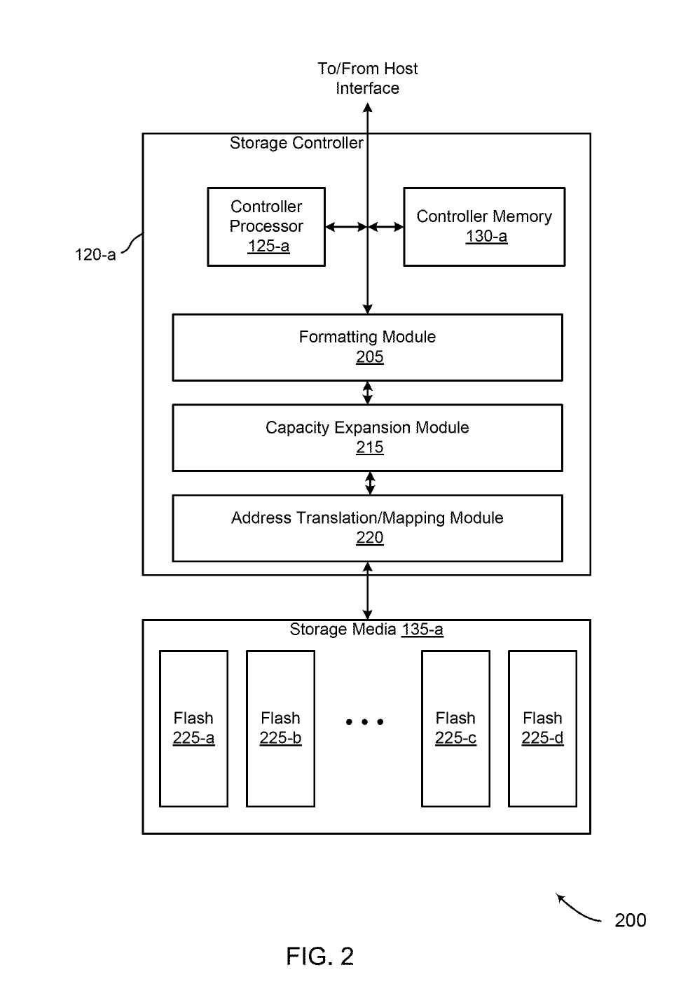

With reference now to FIG. 2, an example 200 of a storage controller 120-a and storage media 135-a is discussed. The storage controller 120-a and storage media 135-a may be examples of the storage controller 120 and storage media 135 of FIG. 1, for example. In this example, the storage controller 120-a may include controller processor 125-a, controller memory 130-a, a formatting module 205, a capacity expansion module 215, and an address translation/mapping module 220. Each of the noted modules may be a means for performing one or more functions related to operation of the storage device.

The storage media 135-a, in some examples, may include non-volatile solid-state storage, such as one or more flash dies 225, which individually contain a portion of the total storage capacity of the device 105. While the example of FIG. 2 illustrates solid state media 135-a, various other examples may implement similar techniques using magnetic media, as will be readily recognized by one of skill in the art. The memory contained within individual flash dies 225 may be further partitioned into blocks which may be referred to as erasure blocks/units. The erasure blocks represent the smallest individually erasable portions of the storage media 130-a. The erasure blocks in turn include a number of pages that represent the smallest portion of data that can be individually programmed and/or read, which may correspond to a sector size in a HDD. In a NAND configuration, for example, the page sizes may range from 512 bytes to 4 kilobytes (kB) and up, and the erasure block sizes may range from 16 KB to 512 KB and up. It will be appreciated that the present embodiments described herein are not limited to any particular size of the pages and blocks.

Irrespective of the additional capacity that may be available at storage media 135-a, the actual storage capacity of the storage media 135-a may be larger than the advertised capacity, due to what sometimes is referred to as overprovisioning of the storage media 135-a. Overprovisioning may be implemented due to the techniques used to manage data storage in solid state memory, which are often different than magnetic storage media. In a magnetic media such as a HDD, each unit of data (e.g., byte, word, sector) may be arbitrarily overwritten by changing a magnetic polarity of a write head as it passes over the magnetic media of the HDD. In contrast, solid state memory cells are first erased by applying a relatively high voltage to the cells before being written, or “programmed ” Such operations may be performed by the address translation/mapping module 220. For a number of reasons, these erasures are often performed on blocks of data (also referred to as “erase units”). An erase unit may include any number of data blocks that are treated as a single unit. When data of an existing page needs to be changed, it may be inefficient to erase and rewrite an entire block of data in which the page resides, because other data within the block may not have changed. Instead, it may be more efficient for the controller processor 125-a to write the changes to empty pages in a new physical location, remap the logical to physical mapping, and mark the old physical locations as invalid/stale. Such operations may result in two or more copies of data being present in the storage media 135-a.

After some time, a threshold number of data storage units within a block may be marked as stale due to changes in data stored within the block. As a result, storage controller 120-a may move any valid data out of the block to a new location and mark the block as erased so that the block is freshly available for programming. The process of tracking invalid/stale data units, and moving of valid data units from an old block to a new block is sometimes collectively referred to as “garbage collection.”

Additionally, wear leveling techniques may be employed by the storage controller 120-a. Such techniques may be performed by controller processor 125-a, and may include tracking the erase and write status of the individual blocks and, in the event of an excessive number of erase and write cycles, may write one or more blocks to another physical location having fewer erase and write cycles.

Overprovisioning techniques provide additional flexibility for garbage collection and wear leveling, by providing available storage for such operations without impacting the advertised available capacity. According to some examples, portions of the storage media 135-a that may be used for overprovisioning capacity may not be formatted when a storage device is manufactured, and this capacity may be formatted once the device is powered on in the field. As this overprovisioning capacity is unlikely to be needed until the device has been operating for some time, such formatting of the overprovisioning capacity in the field may provide efficiencies in the manufacturing process without, or with unlikely, impact on the operations of the device.

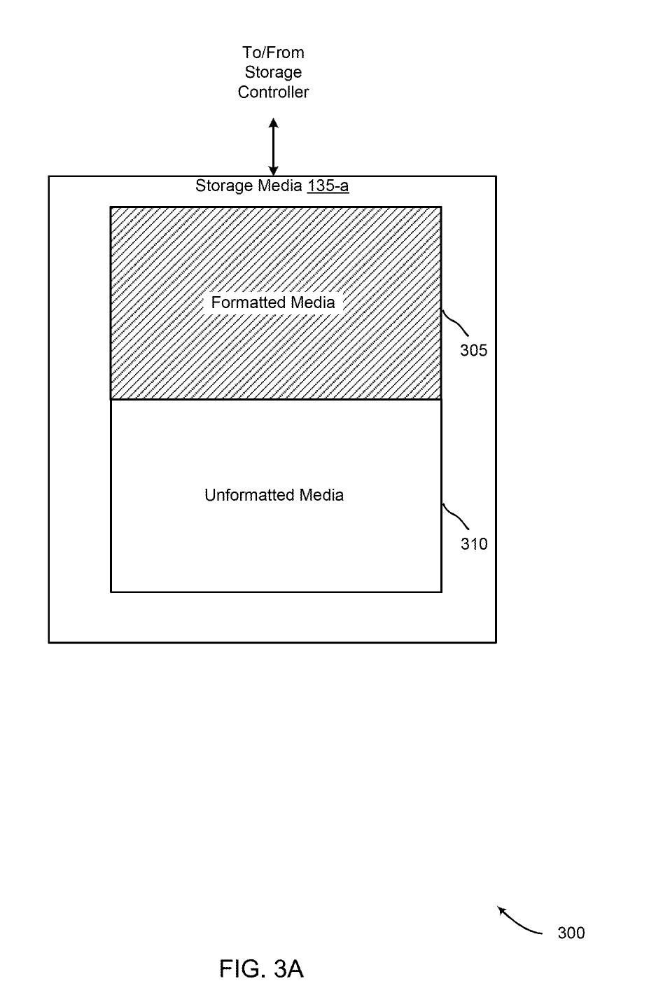

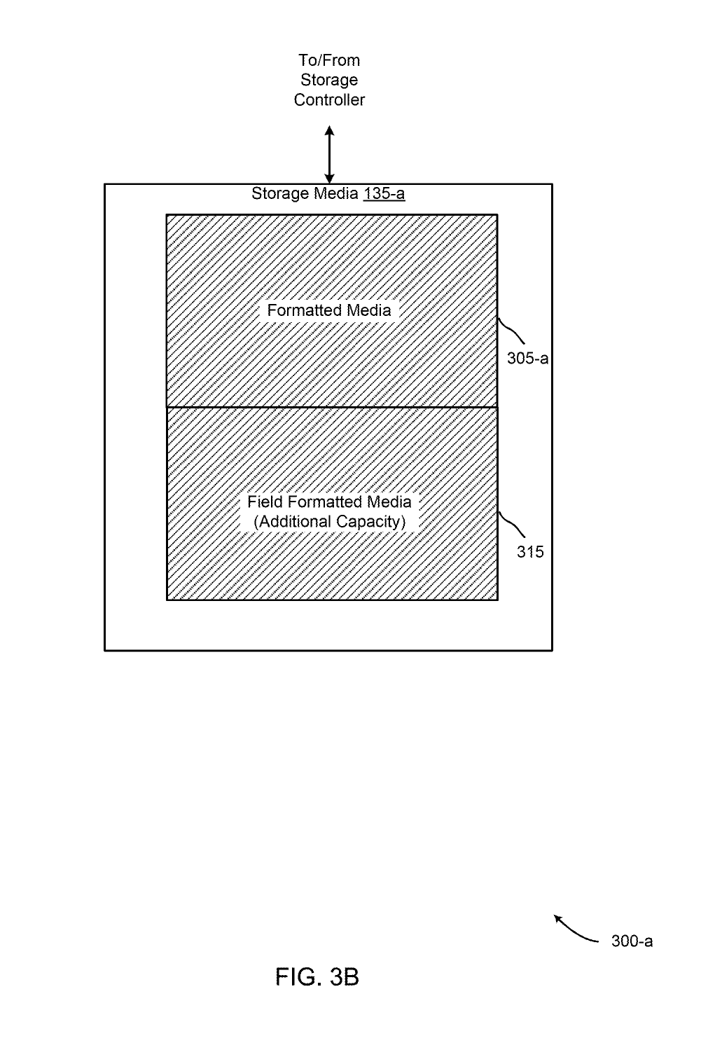

With reference now to FIG. 3A, a block diagram 300 illustrates an example of storage media 135-a in an initial state following manufacture and before being powered-on at a user location, according to various embodiments. In this example, storage media 135-a includes formatted media 305 and unformatted media 310. As noted above, once the device is powered on at a user location (or other location), the controller processor, such as controller processor 125 of FIGS. 1-2, alone or in conjunction with a formatting module, such as formatting module 205 of FIG. 2, may perform formatting operations on the unformatted media 310. Formatting operations for formatting unformatted media 310 are well known operations, including for example, media certification (mapping media defects and fencing them off) processes, deferred formatting, checks of read/write capability and servo information, to name but a few. Such operations can take from tens to hundreds of hours.

Formatting a substantial portion of the storage media 135-a in the field, as mentioned above, can provide a number of efficiencies. For example, by delaying formatting of unformatted media 310, manufacturing cycle time may be reduced. Because less than all of the available capacity is formatted, the storage devices may be coupled with test fixtures for a reduced amount of time, thus allowing more storage devices to be processed through a given set of equipment during a given time. A reduced amount of equipment may result in many millions of dollars in reduced capital and operational expense at manufacturing facilities. For example, reduced numbers of such equipment may result in reduced expenses associated with purchase and maintenance of such equipment, avoidance of operational expenses of such equipment, reduction in required manufacturing floor space, and reduced utility overhead for cooling and electricity.

With reference now to FIG. 3B, a block diagram 300-a illustrates an example of storage media 135-a in a formatted state following formatting of the unformatted media, according to various embodiments. In this example, storage media 135-a includes formatted media 305, and field formatted media 315 corresponding to the unformatted media 310 of FIG. 3A that is now formatted. When a storage device is operating in the field, the controller processor, such as controller processor 125 of FIGS. 1-2, alone or in conjunction with a formatting module, such as formatting module 205 of FIG. 2, may perform formatting operations in conjunction with other storage operations at the device. Accordingly, formatting of the field formatted media 315 may take significantly longer than such formatting in the absence of such other storage operations. As the additional capacity 315 is unlikely to be required for some time after the device is first put into service, such an extended period of time will often be acceptable for users of the device. When the storage controller completes the formatting of the field formatted media 315, it may provide an indication that the operations are complete, and also provide an amount of additional capacity that is available, which may be priced appropriately by a storage access authority, according to various examples.

As mentioned above, the field formatted media 315 may be formatted according to the advanced format (e.g., sector or page size of 4096 bytes rather than 512 bytes). Upon authorization to access the additional capacity and alter the storage format, data stored in the initially formatted media 305-a may be transferred to the additional capacity 315, and the initially formatted area 305-a may be reformatted to the advanced format, thereby providing the initial plus the additional capacity as available and using the advanced format. Thus, additional flexibility may be provided for a data storage device, in that the device may be efficiently reformatted to operate according to different storage formats. Such an option may be desirable if a user initially uses the device in a legacy system, but plans to upgrade the system and also provide additional storage capacity. For example, an operator of a data center may have a number of equipment racks used for providing storage for a customer using legacy storage format, but with plans to transition the customer's data to storage that uses advanced format. In the event that the customer requires additional capacity prior to the transition of the data to storage using advanced format, the data center operator may initially provision the additional capacity with storage devices such as described herein, which may then be easily transitioned and used when the data is migrated to storage devices operating according to advanced format.

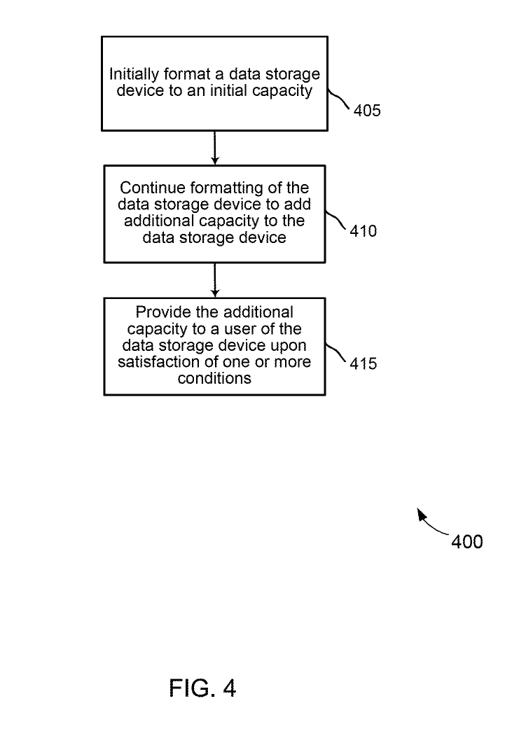

FIG. 4 is a flowchart of a method 400 for storage device formatting and expansion according to various embodiments. For clarity, the method 400 is described below with reference to aspects of one or more of the data storage device 105, storage controller 120, controller processor 125, formatting module 205, and/or capacity expansion module 215 described with reference to FIGS. 1, 2, 3A, and/or 3B. In one implementation, a storage controller 120, or a processor module thereof, may execute one or more sets of codes to control the functional elements of the device to perform the functions described below.

At block 405, the device may initially be formatted to provide an initial capacity. Such initial formatting may be performed at a test fixture in a manufacturing or assembly/test facility, for example. At block 410, the device may continue formatting of the data storage media to add additional capacity to the data storage device. For example, unformatted media may be formatted once the device is powered-on at a user location. At block 415, the device may provide the additional capacity to a user of the data storage device upon satisfaction of one or more conditions. The one or more conditions may be, for example, upon determination that the user has received authorization from an authority to access the additional capacity, similarly as discussed above.

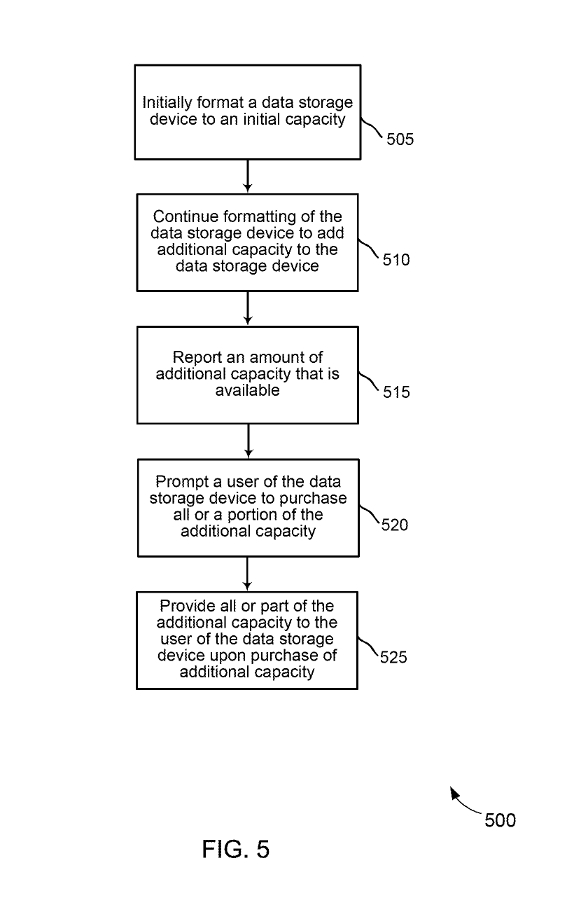

FIG. 5 is a flowchart of a method 500 for storage device formatting and expansion according to various embodiments. For clarity, the method 500 is described below with reference to aspects of one or more of the data storage device 105, storage controller 120, controller processor 125, formatting module 205, and/or capacity expansion module 215 described with reference to FIGS. 1, 2, 3A, and/or 3B. In one implementation, a storage controller 120, or a processor module thereof, may execute one or more sets of codes to control the functional elements of the device to perform the functions described below.

At block 505, the device may initially be formatted to provide an initial capacity.

As discussed above, such initial formatting may be performed at a test fixture in a manufacturing or assembly/test facility, for example. At block 510, the device may continue formatting of the data storage media to add additional capacity to the data storage device. For example, unformatted media may be formatted once the device is powered-on at a user location. At block 515, the device may report an amount of additional capacity that is available after the formatting. As discussed above, such formatting may determine that various portions of the storage media is not working or is unreliable. Accordingly, the final total capacity of a storage device will be dependent upon the percentage of the storage media that is determined to be suitable for storage.

Continuing with reference to FIG. 5, the device prompts a user of the data storage device to purchase all or a portion of the additional capacity, as indicated at block 520. Such a prompt may be through, for example, an application or utility associated with the storage device and that may run on a host computer. In some examples, the data storage device may transmit an indication of the completion of the formatting along with a total amount of available storage to an access authority, which may cause an email or text message to be transmitted to the user, or may update an account of the user to indicate available additional capacity. At block 525, the device may provide all or part of the additional capacity to the user of the data storage device upon purchase of additional capacity. The additional capacity may be purchased according to one or more of the examples discussed above, or according to other examples that will be readily apparent to those skilled in the art.

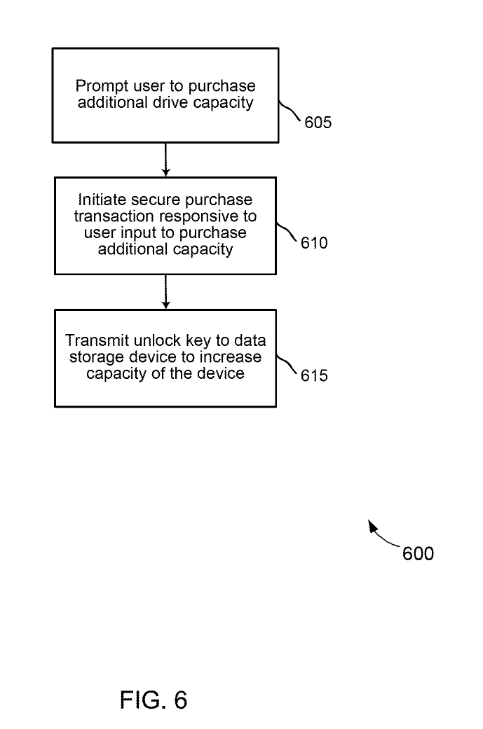

FIG. 6 is a flowchart of a method 600 for storage device formatting and expansion according to various embodiments. For clarity, the method 600 is described below with reference to aspects of one or more of the data storage device 105, storage controller 120, controller processor 125, formatting module 205, and/or capacity expansion module 215 described with reference to FIGS. 1, 2, 3A, and/or 3B. In one implementation, a storage controller 120, or a processor module thereof, may execute one or more sets of codes to control the functional elements of the device to perform the functions described below.

At block 605, a user is prompted to purchase additional drive capacity. As discussed above, such a prompt may be provided through an application, a utility, a text message, or notification through a storage management service, to name but a few examples. At block 610, a secure purchase transaction is initiated responsive to user input to purchase additional capacity. At block 615, a key may be transmitted to unlock the additional capacity, and thereby to increase capacity of the storage device. In some examples, the device may also be provided with an updated part number corresponding to the new advertised storage capacity of the device. Accordingly, the user may be provided with selectable access to different quantities of storage at the data storage device.

The foregoing description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method, comprising:
initially formatting a data storage device to an initial capacity;
continuing formatting of the data storage device to add additional capacity to the data storage device; and
providing the additional capacity to a user of the data storage device upon satisfaction of one or more conditions.

2. The method of claim 1, wherein the initially formatting comprises:
coupling the data storage device with a test fixture at a manufacturing facility; and
formatting a subset of the storage media of the data storage device.

3. The method of claim 2, wherein the initially formatting further comprises:
decoupling the data storage device from the test fixture prior to formatting all of the storage media.

4. The method of claim 2, wherein the continuing formatting comprises:
providing the data storage device to a user; and
formatting the remainder of the data storage media.

5. The method of claim 1, wherein the providing comprises:
prompting the user that the additional capacity is available at the data storage device; and
receiving input from the user that the additional capacity is to be provided.

6. The method of claim 5, wherein the providing further comprises:
initiating, responsive to the receiving input, a purchase transaction for the user to purchase the additional capacity;
receiving an authorization to provide the additional capacity responsive to the initiating; and
modifying one or more operational parameters of the data storage device based on the authorization.

7. The method of claim 6, wherein the one or more operational parameters include one or more of available storage areas for storage of user data, a part number associated with the data storage device, or a sector size for the additional capacity.

8. The method of claim 1, wherein the one or more conditions comprise one or more of:
receipt of a payment from the user;
receipt of a passcode from the user; or
receipt of an instruction from an authority that the additional capacity is to be provided to the user.

9. A data storage device, comprising:
a data storage medium; and
a processor configured to:
initially format the data storage medium to provide an initial capacity for the data storage device;
continue formatting of the data storage medium to add additional capacity to the data storage device; and
provide the additional capacity to a user of the data storage device upon satisfaction of one or more conditions.

10. The data storage device of claim 9, wherein the initial formatting is performed when the data storage device is coupled with a test fixture at a manufacturing facility.

11. The data storage device of claim 10, wherein the additional capacity is formatted after the data storage device is provided to the user.

12. The data storage device of claim 9, wherein the processor is further configured to:
prompt the user that the additional capacity is available at the data storage device; and
receive input from the user that the additional capacity is to be provided.

13. The data storage device of claim 12, wherein the processor is further configured to:
initiate, responsive to receiving the input, a purchase transaction for the user to purchase the additional capacity;
receive an authorization to provide the additional capacity; and
modify one or more operational parameters of the data storage device based on the authorization.

14. The data storage device of claim 13, wherein the one or more operational parameters include one or more of available storage areas for storage of user data, a part number associated with the data storage device, or a sector size for the additional capacity.

15. The data storage device of claim 9, wherein the one or more conditions comprise one or more of:
receipt of a payment from the user;
receipt of a passcode from the user; or
receipt of an instruction from an authority that the additional capacity is to be provided to the user.

16. A method for providing additional capacity for a data storage device following manufacturing of the data storage device, comprising:
providing an initially formatted data storage device to a user;
formatting, after powering on the data storage device at a user location, additional capacity on the data storage device;
determining a final capacity of the data storage device following the formatting at the user location; and
notifying the user that additional capacity is available at the data storage device.

17. The method of claim 16, further comprising:
receiving input from the user that the additional capacity is to be provided for use by the user.

18. The method of claim 17, further comprising:
initiating, responsive to the receiving input, a purchase transaction for the user to purchase the additional capacity;
receiving an authorization to provide the additional capacity responsive to the initiating; and
modifying one or more operational parameters of the data storage device based on the authorization.

19. The method of claim 18, wherein the one or more operational parameters include one or more of available storage areas for storage of user data, a part number associated with the data storage device, or a sector size for the additional capacity.

20. The method of claim 18, wherein the authorization is provided responsive to one or more of:
receipt of a payment from the user;
receipt of a passcode from the user; or
receipt of an instruction from an authority that the additional capacity is to be provided to the user.
